(19) United States
(12) Patent Application Publication
(10) Pub. No.: US 2017/0199318 A1
(43) Pub. Date: Jul. 13, 2017

(54) LIGHT BAR, BACKLIGHT MODULE AND ASSEMBLING METHOD THEREOF AND DISPLAY DEVICE

(71) Applicants: BOE TECHNOLOGY GROUP CO., LTD., Beijing (CN); BOE OPTICAL SCIENCE AND TECHNOLOGY CO., LTD., Suzhou (CN)

(72) Inventor: Xiaoli XIA, Beijing (CN)

(21) Appl. No.: 15/108,170

(22) PCT Filed: Jan. 6, 2016
(86) PCT No.: PCT/CN2016/070235

§ 371 Date: Jun. 24, 2016

(30) Foreign Application Priority Data
Aug. 11, 2015 (CN) 201510489436.6

(51) Int. Cl. F21V 8/00

(52) U.S. Cl. CPC G02B 6/0068; G02B 6/0083; G02B 6/0025; G02B 6/0065

(57) ABSTRACT

The embodiments of the present disclosure disclose a light bar, a backlight module and an assembling method thereof, and a display device, which relate to the field of display techniques, and can improve the defect of a bright boarder in front of the lamp caused by a gap between the light guide plate and an optical membrane thereon. The light bar provided by the embodiment of the present disclosure comprises: a light source, a flexible printed circuit, and a structural member made of light absorbing material; wherein the structural member is sheet shaped and thinner than the flexible printed circuit, and an edge portion of the structural member in a length direction is superposed with an edge portion of the flexible printed circuit in the length direction.

### CROSS-REFERENCES TO RELATED APPLICATIONS

This application claims the benefit and priority of Chinese Patent Application No. 201510489436.6, filed on Aug. 11, 2015, the entire content of which is incorporated herein by reference.

### FIELD OF THE INVENTION

The embodiments of the present disclosure relates to the field of display techniques, and particularly, to a light bar, a backlight module and an assembling method thereof, and a display device.

### BACKGROUND

The backlight module is one of the key components of the liquid crystal display device. Since the liquid crystal itself does not emit light, the main function of the backlight module is to provide the liquid crystal panel with a luminous body having uniformity and high brightness. The basic principle is to dispose a common point or line luminous body used as a light source at one or both sides of a light guide plate, and transforms the point or line luminous body used as a light source into an area luminous body having uniformity and high brightness through an effective optical structure (light guide plate, diffusion sheet, etc.), so that the liquid crystal panel can display images normally. The backlight module can be applied in display devices requiring a backlight such as the digital photo frame, the electronic paper and the cell phone, in addition to the liquid crystal television and the liquid crystal display.

Referring to FIG. 1, which is a schematic diagram of a part of cross-section of a backlight module applied to products such as the cell phone in the prior art, a light source 152 (e.g., LED lamp) is disposed at one edge of the light guide plate 16; a Flexible Printed Circuit (FPC) 151 is provided with black ink on its surface near the light guide plate 16 to absorb light exiting from the vicinity of an edge of the light guide plate 16 near the light source; and an optical film 14 (e.g., diffusion sheet) over a light exiting surface of the light guide plate has an edge portion near the light source to overlap the FPC 151. However, at present, the FPC 151 has a thickness of at least 0.07 mm and a certain hardness, thus a gap exists between the light guide plate 16 and the optical film 14 (e.g., diffusion sheet), as indicated by the dotted box in FIG. 1. As a result, light exiting from the light guide plate 16 leaks at the gap and cannot be absorbed by the black ink, which causes bright borders in front of the lamp, i.e., bright areas occur at the edges of the liquid crystal panel near the light source, and the display effect will be seriously influenced.

In addition, in another existing structure, the FPC 151 is adhered to a position in front of the light guide plate 16 through a black adhesive tape. Meanwhile, the black adhesive tape may also be used to absorb light exiting from the edges of the light guide plate 16. However, since the black adhesive tape (i.e., the black adhesive tape aforementioned) is adhered to the light guide plate 16, the total reflection of light in the light guide plate 16 is damaged, and thus resulting to a light loss. Moreover, the superimposition of the FPC 151 and the adhesive tape increases the thickness, thus there is also a gap between the light guide plate 16 and the optical film (e.g., diffusion sheet) on its light exiting surface, which also causes bright borders in front of the lamp.

### BRIEF SUMMARY OF THE DISCLOSURE

The embodiments of the present disclosure provide a light bar, a backlight module and an assembling method thereof, and a display device, which can improve the defect of a bright boarder in front of the lamp caused by a gap between the light guide plate and an optical film located on its optical membrane.

According to one embodiment described herein, there is provided a light bar, comprising a light source, a flexible printed circuit, and a structural member made of light absorbing material; wherein the structural member is sheet shaped and thinner than the flexible printed circuit, and an edge portion of the structural member in a length direction is superposed with an edge portion of the flexible printed circuit in the length direction.

In one embodiment, the structural member is made of flexible light absorbing material.

In one embodiment, the structural member is made of polyethylene terephthalate plastics.

In one embodiment, the structural member is adhered to the flexible printed circuit through an adhesive layer.

In one embodiment, a length of the structural member is equal to that of the flexible printed circuit.

In one embodiment, a thickness of the structural member is less than 0.07 mm.

According to another embodiment described herein, there is provided a backlight module, comprising any light bar aforementioned.

In one embodiment, the backlight module further comprises a light guide plate, wherein the light bar is disposed on at least one side of the light guide plate, so that the structural member of the light bar is placed on a light exiting surface of the light guide plate.

In one embodiment, the backlight module further comprises a diffusion sheet, wherein an edge portion of the diffusion near the light source press-covers a portion of the structural member not superposed with the flexible printed circuit.

According to further another embodiment described herein, there is provided a display device, comprising any one of the backlight modules aforementioned.

According to still another embodiment described herein, there is provided an assembling method of a backlight module, comprising:

providing a flexible printed circuit;

attaching a sheet-shaped structural member, which is thinner than the flexible printed circuit, to the flexible printed circuit, so that an edge portion of the structural member in a length direction is superposed with an edge portion of the flexible printed circuit in the length direction;

disposing the flexible printed circuit attached with the structural member on at least one side of the light guide plate, so that the structural member is placed on a light exiting surface of the light guide plate; and

press-covering a portion of the structural member not superposed with the flexible printed circuit by an edge portion of the diffusion sheet near a light source.

In one embodiment, the structural member is attached to the flexible printed circuit through an adhesive layer.

Regarding the light bar, the backlight module and the assembling method thereof, and the display device provided by the embodiments of the present disclosure, the thin structural member made of light absorbing material is added into the light bar, and when the light bar is disposed in the backlight module, the optical film (e.g., diffusion sheet) located on the light guide plate press-covers the portion of the structural member not superposed with the flexible printed circuit. Since the structural member is sheet-shaped and does not require a circuit designed thereon, its thickness can be as thin as possible, at least less than the thickness of the flexible printed circuit, thus the gap between the light guide plate and other optical film thereon (e.g., diffusion sheet) can be reduced, thereby improving the defect of a bright boarder in front of the lamp.

### BRIEF DESCRIPTION OF THE DRAWINGS

In order to more clearly describe the technical solutions in the embodiments of the present disclosure, the drawings to be used in the descriptions of those embodiments will be briefly introduced as follows. Obviously, the following drawings just illustrate some embodiments of the present disclosure, and a person skilled in the art can obtain other drawings from them without paying any creative effort.

FIG. 1 is a schematic diagram of a part of cross-section of an existing backlight module;

FIG. 2 is a schematic diagram of constituent parts of a light bar provided by an embodiment of the present disclosure;

FIG. 3 is a schematic diagram of a combination of an FPC and an adhesive tape provided by an embodiment of the present disclosure;

FIG. 4 is a schematic diagram of a structure of a light bar provided by an embodiment of the present disclosure;

FIG. 5 is a schematic diagram of a part of cross-section of backlight module along a width direction of a light bar at a mounting position thereof provided by an embodiment of the present disclosure;

FIG. 6 is a schematic diagram of a structure of a backlight module provided by an embodiment of the present disclosure;

FIG. 7 is a flow diagram of an assembling method of a backlight module provided by an embodiment of the present disclosure; and

FIG. 8 (a) and FIG. 8 (b) are diagrams for comparing effects of an existing backlight module and the backlight module provided by an embodiment of the present disclosure.

### DETAILED DESCRIPTION

Next, the technical solutions of the embodiments of the present disclosure will be clearly and completely described with reference to the drawings of those embodiments.

An embodiment of the present disclosure provides a light bar. As shown in FIGS. 4 and 5, the light bar comprises a light source 152, a flexible printed circuit 151, and a structural member 1 made of light absorbing material, wherein the structural member 1 is a sheet with its thickness less than that of the flexible printed circuit 151, and has its edge portion in the length direction superposed with an edge portion of the flexible printed circuit 151 in the length direction, i.e., the edge portion of the structural member 1 in the length direction is attached to the edge portion of the flexible printed circuit 151 in the length direction.

A person skilled in the art will appreciate that the light source 152, such as an LED lamp or a cathode fluorescent tube, is connected to the flexible printed circuit, so as to provide a point light source or a line light source which forms the backlight module. The light source 152 may be directly integrated with the flexible printed circuit 151, or electrically connected to the light source 152 via wires. In use, the light source may be disposed at one or more edges of the light guide plate of the backlight module, so that light emitted from the light source is coupled into the light guide plate.

To be noted, in the embodiments of the present disclosure, the ‘edge portion’ is not limited to an outermost edge of a part, and may also be a portion extending from the outermost edge to the internal for a certain distance.

Also to be noted, in the embodiments of the present disclosure, the ‘length direction’ is a direction along the long side of the structural member and the flexible printed circuit (e.g., a horizontal direction parallel with the principal plane in FIGS. 2-4, and a direction perpendicular to the principal plane in FIG. 5). The ‘width direction’ is a direction along the short side of the structural member and the flexible printed circuit (e.g., a vertical direction parallel with the principal plane in FIGS. 2-4, and a horizontal direction parallel with the principal plane in FIG. 5).

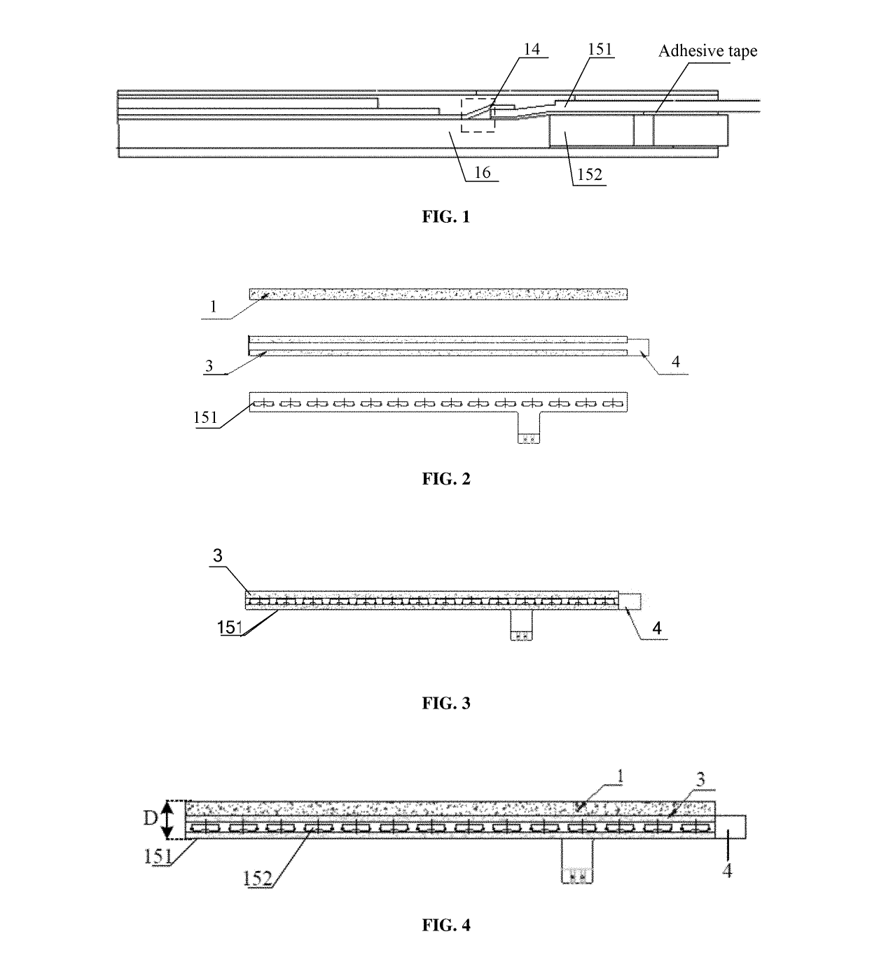

As shown in FIG. 1, in the prior art, the FPC 151 extends to overlap an edge portion of the light guide plate 16 at one side near the light source, and then press-covered by the diffusion sheet 14. In fact, there is no circuit on the extended portion of the FPC 151, thus the FPC 151 can be designed with a small width in the embodiment of the present disclosure, so as to save a space for arranging the structural member 1. In this embodiment, the widths of the FPC 151 and the structural member 1 are not limited, generally provided that the following condition is satisfied: when the structural member 1 is attached to the flexible printed circuit 151, as shown in FIG. 4, a distance D from the lower edge of the flexible printed circuit 151 to the upper edge of the structural member 1 shall be less than or equal to a spatial dimension (perpendicular to the length direction of the light bar 15 in the plane parallel with the light guide plate) reserved for mounting the light bar 15 in the backlight module, and D is obtained by subtracting a superposed dimension of the structural member 1 and the flexible printed circuit 151 from a sum of the widths of the flexible printed circuit 151 and the structural member 1. In one embodiment, when the light bar provided by the embodiment of the present disclosure is applied to the backlight module, under the condition that other designed dimensions of the existing backlight module are not changed, the width D occupied by the flexible printed circuit 151 of the light bar together with the structural member 1 provided by the present disclosure is equal to the spatial dimension reserved for mounting the light bar 15 in the backlight module. In one embodiment, the length of the structural member 1 may be equal to that of the FPC 151, as shown in FIG. 4.

In the embodiment of the present disclosure, the structural member 1 is made of light absorbing material, and has its edge portion in the length direction attached to the edge portion of the flexible printed circuit 151 in the length direction. When the light bar 15 is mounted into the backlight module, the structural member 1 is flattened and placed on the light exiting surface of the light guide plate 16, and press-covered on a portion not superposed with the flexible printed circuit by the diffusion sheet 14 of the backlight module. Light exiting from the edge portion of the light guide plate is absorbed by the structural member 1 to avoid a light leakage. Meanwhile, the total reflection of light in the light guide plate 16 will not be damaged because the structural member is just press-covered on the light guide plate, rather than adhered thereto. In addition, the structural member 1 does not require a circuit designed thereon, and its thickness can be as thin as possible (generally at least less than the thickness of the flexible printed circuit 151), thus the gap between the diffusion sheet 14 and the light guide plate 16 can be reduced effectively (as indicated by the dotted box in FIG. 5), thereby improving the defect of a bright boarder in front of the lamp. In one embodiment of the present disclosure, the thickness of the flexible printed circuit 151 is usually 0.07 mm, thus the thickness of the structural member 1 shall be at least less than 0.07 mm, so as to reduce the gap between the diffusion sheet 14 and the light guide plate 16.

It can be understood that in the backlight module, other optical films besides the diffusion sheet can also be disposed over the light exiting surface of the light guide plate. In that case, by an edge portion of the other optical film near the light source press-covering a portion of the structural member 1 not superposed with the flexible printed circuit, the gap between the light guide plate and the other optical film can be effectively reduced, which also improves the defect of a bright boarder in front of the lamp.

In one embodiment, the structural member 1 described above may be made of flexible light absorbing material, such that the structural member 1 can be more tightly attached to the light guide plate 16, so as to further reduce the gap between the diffusion sheet 24 and the light guide plate 16, and weaken the phenomenon of a bright boarder in front of the lamp. In one embodiment, the structural member 1 may be made of polyethylene terephthalate (PET) plastics with a thickness of 0.025 mm.

The edge portion of the structural member 1 described above may be attached to the flexible printed circuit 151 in various manners conceivable for a person skilled in the art, which is not limited herein. As shown in FIG. 4, an adhesive layer 3 may be disposed on a surface of the flexible printed circuit 151 facing the light guide plate 16, so as to adhere the edge portion of the structural member 1 in the length direction to the edge portion of the flexible printed circuit 151.

The embodiment of the present disclosure further provides a backlight module, comprising any one of the light bars described in the aforementioned embodiments.

To be noted, since the backlight module according to the embodiment of the present disclosure comprises any one of the light bars described in the aforementioned embodiments, the explanations on the positions, shapes and forming materials of various parts and the connection relationships between those parts in the above embodiments relating to the light bar are also suitable for other embodiments of the present disclosure.

In one embodiment, the backlight module may further comprise a light guide plate, wherein a light bar is disposed on at least one side of the light guide plate, so that the structural member is placed on a light exiting surface of the light guide plate. Specifically, the structural member extends along at least one side of the light exiting surface of the light guide plate, and superposes an edge portion of the light exiting surface of the light guide plate.

In this embodiment, light emitted from the light bar is guided into the backlight module via the light guide plate, and a plurality of light exiting points are disposed on the light guide plate so that light can exiting from those light exiting points, thus light emitted from the light bar is guided to each position on the backlight module to form an area luminous body.

In addition, in this embodiment, by disposing the structural member at the edge portion of the light exiting surface of the light guide plate, the optical part (e.g., an optical film such as diffusion sheet) of the backlight module located above the light guide plate can press-cover the structural member. Since the structural member is thin, the gap between the light guide plate and the optical part thereon can be reduced, so as to improve the defect of a bright boarder in front of the lamp on the liquid crystal display panel formed by the backlight module.

In one embodiment, the backlight module may further comprise a diffusion sheet, and an edge portion of the diffusion sheet near the light source press-covering a portion of the structural member not superposed with the flexible printed circuit. In this embodiment, the diffusion sheet functions to uniformly diffuse light exiting from the light exiting points of the light guide plate. In addition, by press-covering the thin structural member with the diffusion sheet, the gap between the light guide plate and the diffusion sheet, so as to improve the defect of a bright boarder in front of the lamp on the liquid crystal display panel formed by the backlight module.

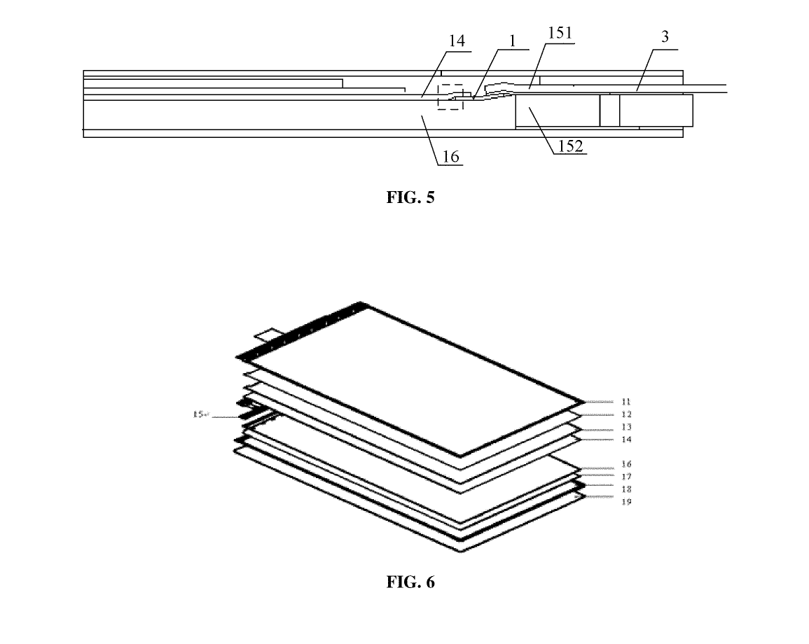

In a specific embodiment, as shown in FIG. 6, the backlight module comprises, from bottom to top, a backboard 19, a rubber frame 18, a reflective sheet 17, a light guide plate 16, a diffusion sheet 14, a lower prism 13, an upper prism 12, and a light shielding adhesive tape 11, and further comprises a light bar 15 disposed on one side of the light guide plate 16. As shown in FIG. 5, the structural member 1 of the light bar 15 is flattened and placed on the light exiting surface of the light guide plate 16 and press-covered by the edge portion of the diffusion sheet 14 near the light source.

A person skilled in the art will appreciate that the structure of the backlight module is not limited to the above parts, and may comprise other one or more optical films upon the actual demand, which is not described in details herein.

Since the backlight module provided by the present disclosure uses light bar described above, the optical energy utilization rate can be increased and the defect of a bright boarder in front of the lamp can be improved.

The embodiment of the present disclosure further provides a display device, comprising any one of backlight modules aforementioned. Since the display device uses the backlight module of the present disclosure, it can be seen from the above description that the display device provided by this embodiment increases the optical energy utilization rate and improves the defect of a bright boarder in front of the lamp, thus the display effect is better. The display device may be any product or part having a display function, such as a liquid crystal panel, an electronic paper, a cell phone, a tablet computer, a television, a display, a notebook computer, a digital photo frame, and a navigator.

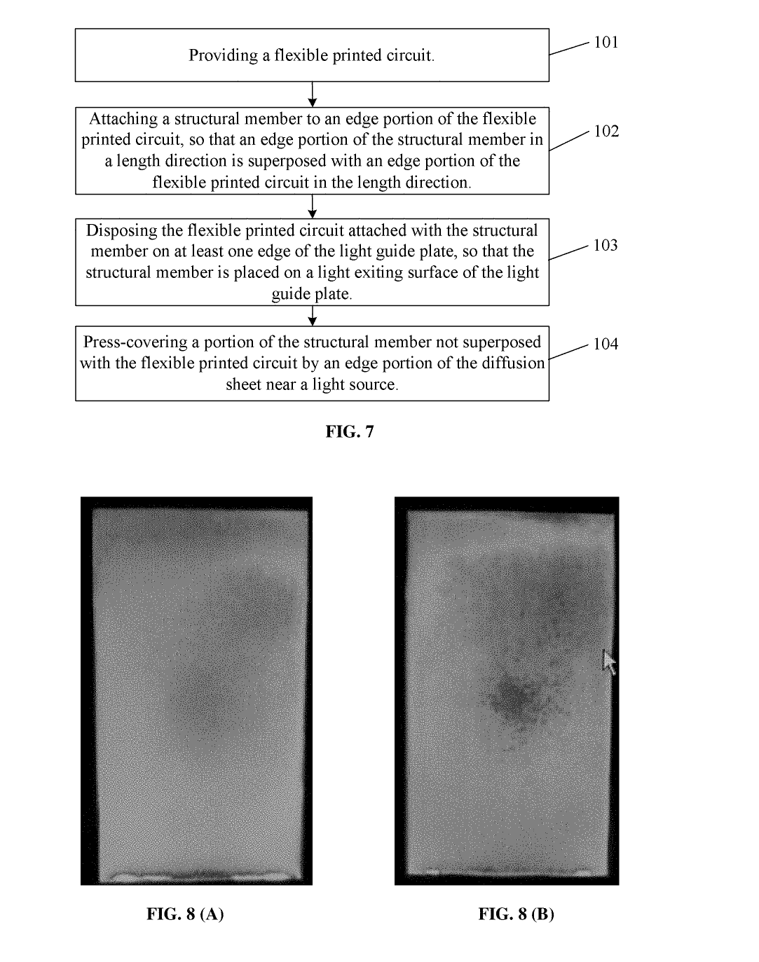

The embodiment of the present disclosure further provides an assembling method of a backlight module. As shown in FIG. 7, the assembling method comprises the following steps.

S101: providing a flexible printed circuit 151.

The flexible printed circuit may be integrated with an LED lamp or a cathode fluorescent tube, or connected with an LED lamp or a cathode fluorescent tube via wires, so as to serve as a light source for the backlight module.

S102: attaching a sheet-shaped structural member 1, which is thinner than the flexible printed circuit 151, to an edge portion of the flexible printed circuit 151, so that an edge portion of the structural member 1 in a length direction is superposed with an edge portion of the flexible printed circuit 151 in the length direction.

In one embodiment, the edge portion of the structural member 1 in the length direction may be attached to the edge portion of the flexible printed circuit via an adhesive layer.

S103: disposing the flexible printed circuit 151 attached with the structural member 1 on at least one edge of the light guide plate, so that the structural member is placed on a light exiting surface of the light guide plate.

Wherein, the portion of the structural member 1 not superposed with the flexible printed circuit may be flattened and placed on the light exiting surface of the light guide plate 16.

S104: press-covering the portion of the structural member 1 not superposed with the flexible printed circuit by an edge portion of the diffusion sheet 14 near a light source.

It can be understood that in the assembling method of a backlight module provided by the embodiment of the present disclosure, steps of mounting other films may be further comprised before step S101, after step S104 and between steps S101 to S104. For example, steps of assembling a backboard, a rubber frame, a reflective sheet, etc. may be comprised before step S101; and steps of assembling optical parts such as a prism, a lens, etc. may be comprised after step S104. Since those films and their mounting steps may be any required films and steps known to a person skilled in the art, they are not described in details herein. The optical energy utilization rate can be increased and the defect of a bright boarder in front of the lamp can be improved by assembling the light bar into the backlight module according to the assembling method of the backlight module provided by this embodiment, and the display effect can be improved by applying the backlight module to the display device.

In order that a person skilled in the art better understands the structures of the light bar and the backlight module provided by the embodiments of the present disclosure, next the present disclosure will be described in details through specific embodiments.

In this embodiment, while it is ensured that the FPC 151 and the light guide plate 16 are adhered to each other effectively, the width of the FPC 151 is reduced, the front end of the FPC 151 is designed with the structural member 1 made of black PET with a thickness of 0.025 mm, and the diffusion sheet 14 is designed to overlap the structural member 1.

Specifically as shown in FIG. 2, the light bar of this embodiment comprises the FPC 151 (integrated with an LED lamp), the adhesive tape 3 and the structural member 1. Firstly, the adhesive tape 3 is combined with the FPC 151, i.e., the adhesive tape 3 is adhered to one side of the FPC 151 which faces the light guide plate 16 during mounting, wherein the right end in the figure is a tear hand 4 of the adhesive tape 3; next, the structural member 1 made of black PET is combined with the combination of the adhesive tape 3 and the FPC 151 to form the light bar as shown in FIG. 4. Through this step, the structural member 1 is adhered to the edge of the FPC 151 along the length direction.

The working procedure before mounting the light bar of the backlight module is carried out in the existing flow, and then the light bar as shown in FIG. 4 is mounted so that its one side attached with the structural member 1 faces inwards, and the portion of the structural member 1 not attached to the FPC is flattened and placed on the light exiting surface of the light guide plate 16; next, the diffusion sheet 14 is mounted with its light proximal end press-covers the structural member 1; and the subsequent working procedure proceeds to complete the assembly of the backlight module.

In this embodiment, the structural member 1 is made of non-viscous black PET, thus external parasitic light can be effectively absorbed without any loss of optical energy inside the light guide plate. Meanwhile, the structural member 1 made of PET has a very small thickness (0.025 mm), which can effectively reduce the gap between the light guide plate 16 and related part, increase the optical energy utilization rate and improve the defect of a bright boarder in front of the lamp. In addition, the elevation P of the diffusion sheet can also be decreased by using the light bar and the mounting method provided by the present disclosure, so as to solve the existing problems such as arching and shifting of the films which can be easily caused during the press-covering of the light shielding adhesive tape.

FIG. 8 (a) and FIG. 8 (b) are diagrams for comparing effects of an existing backlight module and a backlight module provided by the present disclosure. It can be seen that the bright boarder at the lower end of the backlight module as shown in FIG. 8 (a) is obvious, while the bright boarder at the lower end of the backlight module of the present disclosure as shown in FIG. 8 (b) is not obvious.

To be noted, in the descriptions of the present disclosure, the orientations and positional relationships indicated by the terms ‘on’, ‘above’, ‘under’, ‘below’, ‘top’, ‘bottom’, ‘between’, etc. are based on those illustrated in the drawings, just for facilitating the descriptions of the present disclosure and simplifying the descriptions, rather than specifying or implying that the concerned apparatuses or elements must have particular orientations, or configured and operated in particular orientations, and hence cannot be understood as limitations to the present disclosure. For example, when an element or layer is referred to as being ‘on’ another element or layer, it may be directly located on the another element or layer, or there may be an intermediate element or layer; similarly, when an element or layer is referred to as being ‘under’ another element or layer, it may be directly located under the another element or layer, or there may be at least one intermediate layer or element; and when an element or layer is referred to as being ‘between’ two elements or layers, it may be an unique element or layer between the two elements or layers, or there may be more than one intermediate element or layer.

Further to be noted, when the elements and the embodiments of the present disclosure are introduced, the articles ‘a/an’, ‘one’, ‘the’ and ‘said’ are intended to represent the existence of one or more elements. Unless otherwise specified, ‘a plurality of’ means two or more. The expressions ‘comprise’, ‘include’, ‘contain’ and ‘have’ are intended as inclusive and mean that there may be other elements besides those listed.

The above descriptions are just specific embodiments of the present disclosure, while the protection scope of the present disclosure is not limited thereto. Any change or replacement easily conceivable to a person skilled in the art within the technical scope revealed by the present disclosure shall be covered by the protection scope of the present disclosure. Therefore, the protection scope of the present disclosure shall be determined by those of the claims.

1. A light bar, comprising a light source, a flexible printed circuit, and a structural member made of light absorbing material;
wherein the structural member is sheet shaped and thinner than the flexible printed circuit, and an edge portion of the structural member in a length direction is superposed with an edge portion of the flexible printed circuit in the length direction.

2. The light bar according to claim 1, wherein the structural member is made of flexible light absorbing material.

3. The light bar according to claim 2, wherein the structural member is made of polyethylene terephthalate plastics.

4. The light bar according to claim 1, wherein the structural member is adhered to the flexible printed circuit through an adhesive layer.

5. The light bar according to claim 1, wherein a length of the structural member is equal to that of the flexible printed circuit.

6. The light bar according to claim 1, wherein a thickness of the structural member is less than 0.07 mm.

7. A backlight module, comprising a light bar,
wherein the light bar comprises a light source, a flexible printed circuit, and a structural member made of light absorbing material;
wherein the structural member is sheet shaped and thinner than the flexible printed circuit, and an edge portion of the structural member in a length direction is superposed with an edge portion of the flexible printed circuit in the length direction.

8. The backlight module according to claim 7, further comprising a light guide plate, wherein the light bar is disposed on at least one side of the light guide plate, so that the structural member of the light bar is placed on a light exiting surface of the light guide plate.

9. The backlight module according to claim 8, further comprising a diffusion sheet, wherein an edge portion of the diffusion sheet near the light source press-covers a portion of the structural member not superposed with the flexible printed circuit.

10. A display device, comprising the backlight module according to claim 7.

11. An assembling method of a backlight module, comprising:
providing a flexible printed circuit;
attaching a sheet-shaped structural member, which is thinner than the flexible printed circuit, to the flexible printed circuit, so that an edge portion of the structural member in a length direction is superposed with an edge portion of the flexible printed circuit in the length direction;
disposing the flexible printed circuit attached with the structural member on at least one side of the light guide plate, so that the structural member is placed on a light exiting surface of the light guide plate; and
press-covering a portion of the structural member not superposed with the flexible printed circuit by an edge portion of the diffusion sheet near a light source.

12. The assembling method of a backlight module according to claim 11, wherein attaching the sheet-shaped structural member, which is thinner than the flexible printed circuit, to the flexible printed circuit comprises:
attaching the sheet-shaped structural member, which is thinner than the flexible printed circuit, to the flexible printed circuit through an adhesive layer.

13. The assembling method of a backlight module according to claim 11, wherein the structural member is made of flexible light absorbing material.

14. The backlight module according to claim 7, wherein the structural member is made of flexible light absorbing material.

15. The backlight module according to claim 14, wherein the structural member is made of polyethylene terephthalate plastics.

16. The backlight module according to claim 7, wherein the structural member is adhered to the flexible printed circuit through an adhesive layer.

17. The backlight module according to claim 7, wherein a length of the structural member is equal to that of the flexible printed circuit.

18. The backlight module according to claim 7, wherein a thickness of the structural member is less than 0.07 mm.

19. The display device according to claim 10, further comprising a light guide plate, wherein the light bar is disposed on at least one side of the light guide plate, so that the structural member of the light bar is placed on a light exiting surface of the light guide plate.

20. The display device according to claim 19, further comprising a diffusion sheet, wherein an edge portion of the diffusion sheet near the light source press-covers a portion of the structural member not superposed with the flexible printed circuit.
